(19) United States
(12) Patent Application Publication
(10) Pub. No.: US 2020/0307555 A1
(43) Pub. Date: Oct. 1, 2020

(54) KEY FOB UTILIZATION FOR VEHICLE REMOTE PARK-ASSIST

(71) Applicant: Ford Global Technologies, LLC, Dearborn, MI (US)

(72) Inventors: John Robert Van Wiemeersch, Novi, MI (US); Daniel M. King, Northville, MI (US); Erick Michael Lavoie, Dearborn, MI (US); Vivekanandh Elangovan, Canton, MI (US); Ali Hassani, Ann Arbor, MI (US); Alyssa Chatten, Huntington Woods, MI (US)

(21) Appl. No.: 16/372,335

(22) Filed: Apr. 1, 2019

(51) Int. Cl. B60W 30/06; G07C 9/00; G08C 17/02

(52) U.S. Cl. CPC B60W 30/06; G07C 2009/00507; G08C 17/02; G07C 9/00309

(57) ABSTRACT

Method and apparatus are disclosed for key fob utilization for vehicle remote park-assist. An example vehicle system for remote park-assist (RePA) includes a key fob. The key fob includes a low frequency (LF) antenna to receive a beacon and an ultra-high frequency (UHF) antenna to transmit a return signal including a distance indicator and a RePA signal. The example vehicle system also includes a vehicle. The vehicle includes an LF module to transmit the beacon at a predefined interval, a receiver-transceiver module to receive the return signal and the RePA signal, a controller to enable RePA responsive to determining that the distance indicator is less than a tethering threshold distance, and an autonomy unit to perform RePA based on the RePA signal.

### CROSS-REFERENCE TO RELATED APPLICATIONS

This application is related to U.S. application Ser. No. ______, Docket No. 84107827 (NGE File No. 026780.9269), filed on Apr. 1, 2019, and U.S. application Ser. No. ______, Docket No. 84108177 (NGE File No. 026780.9271), filed on Apr. 1, 2019, which are incorporated herein by reference in their entireties.

### TECHNICAL FIELD

The present disclosure generally relates to key fobs and, more specifically, to key fob utilization for vehicle remote park-assist.

### BACKGROUND

Many vehicles include functions in which at least some motive functions of a vehicle are autonomously controlled by the vehicle. For instance, some vehicles include cruise control in which the vehicle controls acceleration and/or deceleration of the vehicle so that a speed of the vehicle is maintained. Further, some vehicles include park-assist features in which the vehicle autonomously and/or semi-autonomously controls motive functions of the vehicle to park the vehicle into a parking spot. For instance, some vehicles include a remote park-assist system that enables a user to initiate park-assist features from a remote location.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for key fob utilization for vehicle remote park-assist. An example disclosed vehicle system for remote park-assist (RePA) includes a key fob. The key fob includes a low frequency (LF) antenna to receive a beacon and an ultra-high frequency (UHF) antenna to transmit a return signal including a distance indicator and a RePA signal. The example disclosed vehicle system also includes a vehicle. The vehicle includes an LF module to transmit the beacon at a predefined interval, a receiver-transceiver module to receive the return signal and the RePA signal, a controller to enable RePA responsive to determining that the distance indicator is less than a tethering threshold distance, and an autonomy unit to perform RePA based on the RePA signal.

An example disclosed method includes transmitting a beacon via a low frequency (LF) module of a vehicle and transmitting, via a UHF antenna of a key fob, a return signal that includes a distance indicator in response to an LF antenna of the key fob receiving the beacon. The example disclosed method also includes, upon receiving the return signal via a receiver-transceiver module of the vehicle, enabling RePA, via a vehicle processor, responsive to determining the distance indicator is less than a tethering threshold distance. The example disclosed method also includes receiving, via the receiver-transceiver module, a RePA signal transmitted by the UHF antenna while RePA is enabled and performing RePA via an autonomy unit based on the RePA signal.

An example disclosed vehicle includes an LF module configured to transmit a beacon at a predefined interval and a receiver-transceiver module configured to receive a return signal and a RePA signal from a key fob. The return signal includes a distance indicator that identifies a distance to the key fob. The example disclosed vehicle also includes a controller configured to enable RePA responsive to determining that the distance indicator of the return signal is less than a tethering threshold distance. The example disclosed vehicle also includes an autonomy unit to perform RePA based on the RePA signal that is received by the receiver-transceiver module while RePA is enabled.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates a vehicle and a key fob in accordance with the teachings herein.

FIG. 2 depicts a schematic of communication between the key fob and the vehicle of FIG. 1.

FIG. 3 depicts an example of the key fob of FIG. 1.

FIG. 4 depicts another example of the key fob of FIG. 1.

FIG. 5 is a block diagram of electronic components of the key fob of FIG. 1.

FIG. 6 is a block diagram of electronic components of the vehicle of FIG. 1.

FIG. 7 is an example flowchart for utilizing a key fob to initiate remote park-assist in accordance with the teachings herein.

FIG. 8 is another example flowchart for utilizing a key fob to initiate remote park-assist in accordance with the teachings herein.

FIG. 9 is another example flowchart for performing remote park-assist based on communication with a key fob in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Many vehicles include functions in which at least some motive functions of a vehicle are autonomously controlled by the vehicle. For instance, some vehicles include cruise control in which the vehicle controls acceleration and/or deceleration of the vehicle so that a speed of the vehicle is maintained. Further, some vehicles include park-assist features in which the vehicle autonomously and/or semi-autonomously controls motive functions of the vehicle to park the vehicle into a parking spot. For instance, some vehicles include a remote park-assist system that enables a user to initiate park-assist features from a remote location outside the vehicle.

Some remote park-assist systems use both a key fob and a mobile device (a smart phone, a wearable, a smart watch, a tablet, etc.) carried by a user of the vehicle. In some instances, the remote park-assist system uses the key fob to localize and/or determine a distance to the user relative to the vehicle and uses the mobile device to send signals to initiate park-assist motive functions of the vehicle, for example, when a user carries both the key fob and the mobile device to perform a park-assist maneuver. For instance, the key fob may potentially be used for accurately determining a distance between the user and the vehicle based on low-frequency and/or higher frequency communication. Further, the mobile device may potentially be used to initiate the park-assist motive functions to facilitate the simultaneous localization of the user and sending of park-assist instructions. An example remote park-assist system that utilizes both a key fob and a mobile device carried by a user of a vehicle is disclosed in further detail in U.S. application Ser. No. 15/948,428, filed on Apr. 9, 2018, which is incorporated by reference in its entirety. In some such instances, the mobile device potentially may be unavailable for remote park-assist use. For instance, the mobile device may have been misplaced by the user and/or have a discharged battery. Further, some users potentially may find it burdensome to carry two devices, namely the key fob and the mobile device, to initiate remote park-assist for a vehicle.

Example methods and apparatus disclosed herein include a remote park-assist (RePA) system that enables a key fob to be used for both the localization of a user and the sending of signals to initiate park-assist motive functions. Examples disclosed herein enable a key fob to be utilized as a backup remote device for initiating motive functions for RePA (e.g., if a mobile device otherwise used for initiating motive functions for RePA is misplaced or discharged). To simultaneously manage localization and RePA command communication while the key fob operates as a backup device, examples disclosed herein (1) determine a schedule for localization communication and RePA command communication, (2) limit performance of RePA events initiated via a key fob, and/or (3) include low-energy communication (e.g., BLE communication) capabilities for the key fob that are to be designated for RePA command communication. To limit battery-consumption of a battery of a key fob utilized to initiate RePA, examples disclosed herein discourage the repeated use of a key fob as a backup RePA device by (1) only permitting such use if a mobile device has recently been used for the RePA system, (2) only permitting such use if a mobile device is not in communication with the vehicle, (3) slowing down a speed and/or travel distance of the vehicle while using the key fob as a backup RePA device, and/or (4) suspending use of an LED of a key fob while the key fob is being used as a backup RePA device.

As used herein, a “key fob” refers to a dedicated electronic remote device that wirelessly communicates with a vehicle to unlock and/or lock vehicle door(s), unlatch the vehicle door(s), open and/or close the vehicle door(s), activate an engine of the vehicle, and/or control other function(s) of the vehicle. As used herein, a “mobile device” refers to an electronic remote device that is configured to (1) wirelessly communicate with a vehicle to control vehicle function(s) and (2) wirelessly communicate with other device(s) to control non-vehicle-related functions. Example mobile devices include a smart phone, a wearable, a smart watch, a tablet, etc.

As used herein, “vehicle park-assist” and “park-assist” refer to a system in which a vehicle controls its motive functions, without direct steering or velocity input from an operator (e.g., a driver), to autonomously park within a parking spot. For example, an autonomy unit of a park-assist system controls the motive functions of the vehicle upon receiving an initiation signal from the operator. As used herein, “remote parking,” “vehicle remote park-assist,” “remote park-assist,” and “RePA” refer to a system in which a vehicle controls its motive functions, without direct steering or velocity input from an operator (e.g., a driver), to autonomously park within a parking spot while the operator is located outside of the vehicle. For example, an autonomy unit of a remote park-assist system controls the motive functions of the vehicle upon receiving a remote initiation signal from a mobile device of the operator.

As used herein, “remote entry,” “remote keyless entry,” and “RKE” refer to a vehicle system that unlocks and/or opens one or more doors of a vehicle in response to receiving a signal to do so from an authorized remote device (e.g., a key fob, a mobile device). As used herein, “remote start” refers to a vehicle system that starts or activates an engine of a vehicle in response to receiving a signal to do so from an authorized remote device (e.g., a key fob, a mobile device).

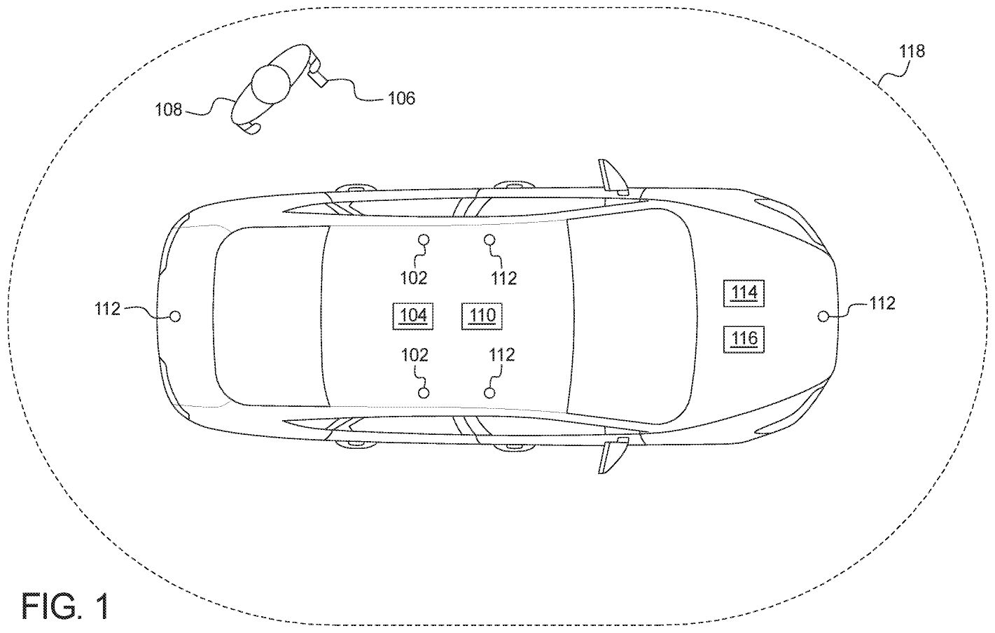

Turning to the figures, FIG. 1 illustrates an example vehicle 100 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be semi-autonomous (e.g., some routine motive functions controlled by the vehicle 100) and/or autonomous (e.g., motive functions are controlled by the vehicle 100 without direct driver input).

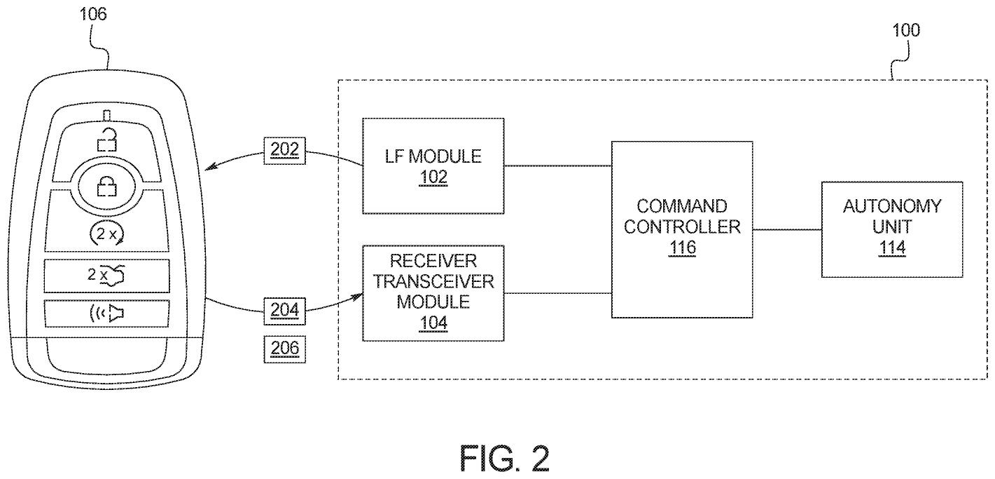

In the illustrated example, the vehicle 100 includes one or more low frequency (LF) modules 102 and a receiver-transceiver module 104. Each of the LF modules 102 and the receiver-transceiver module 104 includes hardware (e.g., processors, memory, storage, antenna, etc.) and software to control wireless network interfaces. For example, the LF modules 102 include hardware and software to communicate via LF signals (e.g., 125 kHz to 134.5 kHz, etc.), and the receiver-transceiver module 104 include hardware and software to communicate via ultra-high frequency (UHF) signals (e.g., 314 MHz to 904 MHz, etc.) and/or other medium-frequency signals. As disclosed in greater detail below with respect to FIG. 2, the LF modules 102 and the receiver-transceiver module 104 are configured to wirelessly communicate with a key fob 106 of a user 108 to determine a distance between the key fob 106 and the vehicle 100.

Further, in the illustrated example, the vehicle 100 of the illustrated example includes a communication module 110 and antenna modules 112 that are configured for wireless communication with the key fob 106 of the user 108. For example, the key fob 106 and/or a mobile device (a smart phone, a wearable, a smart watch, a tablet, etc.) is configured to communicate with the communication module 110 and antenna modules 112 to initiate vehicle functions, such as passive entry, passive start, remote entry, remote start, remote park-assist, etc. Further, in some examples, the communication module 110 and the antenna modules 112 are configured to determine a distance to the key fob 106 for initiation of one or more of the vehicle function(s). The communication module 110 and the antenna modules 112 are low-energy communication modules that are configured to wirelessly communicate with a mobile device of the user 108.

The antenna modules 112 include hardware (e.g., processors, memory, storage, antenna, etc.) and software to control wireless network interface(s). For example, the antenna modules 112 are configured for personal or local area wireless network protocols (e.g., Bluetooth®, Bluetooth® Low Energy (BLE), Zigbee®, Z-Wave®, etc.). In some examples, the antenna modules 112 may be referred to as “BLE Antenna Modules (BLEAMs)” when the antenna modules 112 are configured to implement BLE communication. In some examples, the antenna modules 112 communicatively couple to a remote device (e.g., the key fob 106, a mobile device) and measure and/or receive measurements of the signal strength of the signals (e.g., received signal strength indicators) broadcast by the remote device to facilitate determining a distance to and/or a location of the remote device relative to the vehicle 100. Further, in some examples, one or more of the antenna modules 112 are located inside a cabin of the vehicle 100 to determine when a remote device is within the cabin and/or to localize the remote device within the cabin (e.g., to enable passive start of the vehicle 100). In some examples, the distance between the key fob 106 and the vehicle 100 may be determined utilizing time-of-flight technology to measure a roundtrip time of communication (e.g., BLE, Wi-Fi, Ultra-wideband (UWB), etc.) between the key fob 106 and the communication module 110. Further, in some examples, the distance between the key fob 106 and the vehicle 100 may be determined utilizing angle-of-arrival technology and BLE communication.

The communication module 110 is communicatively coupled to the antenna modules 112. For example, the communication module 110 is communicatively coupled to the antenna modules 112 to track a distance to and/or a location of a remote device (e.g., the key fob 106, a mobile device) relative to the vehicle 100. The communication module 110 may be referred to as a “BLE Module (BLEM)” when the antenna modules 112 are configured to implement BLE communication. In some examples, the communication module 110 is configured to receive and analyze the signal strength measurements (e.g., received signal strength indicators) between the antenna modules 112 and a remote device. Based on these measurements, the communication module 110 determines a location of the remote device relative to the vehicle 100 to facilitate initiation of one or more vehicle functions. For example, a passive entry function is initiated upon the communication module 110 determining that the remote device is near a vehicle door exterior and/or a passive start function is initiated upon the communication module 110 determining that the remote device is within the cabin of the vehicle 100.

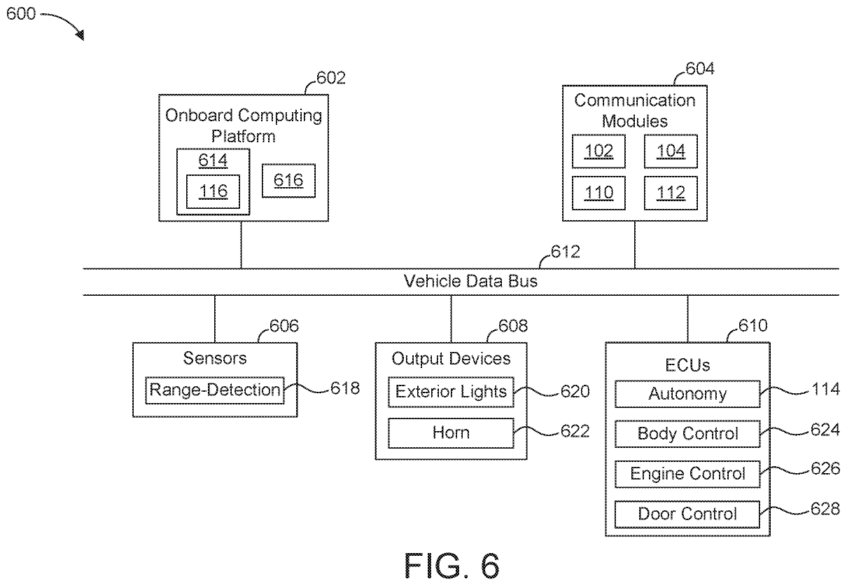

The vehicle 100 of the illustrated example also includes an autonomy unit 114. The autonomy unit 114 is an electronic control unit that is configured to perform autonomous and/or semi-autonomous motive functions for the vehicle 100. For example, the autonomy unit 114 is configured to control performance of autonomous and/or semi-autonomous driving maneuvers of the vehicle 100 based upon, at least in part, data collected by range-detection sensors of the vehicle 100 (e.g., range-detection sensors 618 of FIG. 6). In the illustrated example, the autonomy unit 114 controls performance of autonomous and/or semi-autonomous driving maneuvers for remote park-assist of the vehicle 100.

In the illustrated example, the vehicle 100 also includes a command controller 116. For example, the command controller 116 is configured to identify and process signals collected from the key fob 106 and/or a mobile device of the user 108 by communication module(s) of the vehicle 100 (e.g., the LF modules 102, the receiver-transceiver module 104, the communication module 110, the antenna modules 112, etc.).

In operation, the key fob 106 is utilized to initiate remote park-assist and/or other vehicle functions of the vehicle 100. For example, the vehicle 100 of the illustrated example is permitted to autonomously perform motive functions for remote park-assist when the user 108 is within a tethering range 118 of the vehicle 100 and is prohibited from autonomously performing the motive functions when the user 108 is outside of the tethering range 118. For instance, some governmental agencies have instituted regulations that require the user 108 be within the tethering range 118 of the vehicle 100 while the vehicle 100 is autonomously performing remote park-assist motive functions. The tethering range 118 of the illustrated example is defined to extend to a predetermined distance (e.g., 6 meters) from an exterior surface of the vehicle 100. The user 108 is within the tethering range 118 of the vehicle 100 if a distance between the user 108 and the exterior surface of the vehicle 100 is less than or equal to the predetermined distance of the tethering range 118.

As used herein, to “tether” refers to authenticating a key fob and/or mobile device and its distance to a vehicle to initiate remote parking for the vehicle. For example, a vehicle is configured to perform remote parking upon receiving instruction(s) to do so from a key fob and/or mobile device that is tethered to the vehicle and is configured to not perform remote parking upon receiving instruction(s) from a key fob and/or mobile device that is untethered from the vehicle. As used herein, a “tethered” device refers to a key fob and/or a mobile device that is enabled to send instructions to a vehicle to perform remote parking. For example, a key fob and/or mobile device is tethered to a vehicle responsive to the key fob and/or mobile device being wirelessly communicatively coupled to the vehicle and located within a predetermined tethering range (e.g., 6 meters) of the vehicle. In such examples, a key fob and/or mobile device that sends instructions to a vehicle to perform remote parking is untethered from the vehicle if the key fob and/or mobile device is beyond the tethering range of the vehicle.

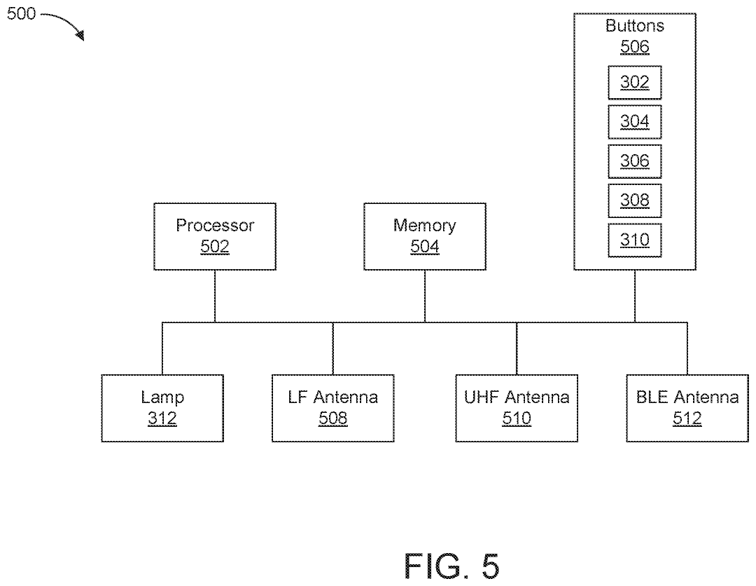

In some examples, a remote park-assist system utilizes both the key fob 106 and a mobile device (a smart phone, a wearable, a smart watch, a tablet, etc.) carried by the user 108 to initiate remote park-assist for the vehicle 100. For example, the command controller 116 utilizes communication with the key fob 106 to determine the distance between the user 108 and the vehicle and utilizes communication with the mobile device for receiving remote park-assist signals from the user 108. The command controller 116 utilizes communication between the key fob 106 and the LF modules 102 and/or the receiver-transceiver module 104 to determine the distance between the vehicle 100 and the key fob 106. For example, the command controller 116 determines the distance between the user 108 and the vehicle 100 based upon low-frequency communication between the key fob 106 and the LF modules 102 rather than the wireless communication with the mobile device, because calculating a distance based upon a received signal strength indicator (RSSI) of low-frequency communication is more accurate than calculating a distance based upon an RSSI of BLE, Wi-Fi, ultra-wideband (UWB), and/or communication signals with similar sample rates. That is, because the key fob 106 has an LF antenna (e.g., an LF antenna 508 of FIG. 5) for low-frequency communication, the command controller 116 utilizes the RSSI of communication with the key fob 106 to approximate a distance between the user 108 and the vehicle 100. Communication between the key fob 106 and the vehicle 100 that is utilized for determining the distance between the two is disclosed below in further detail with respect to FIG. 2.

Further, in such examples, the command controller 116 utilizes communication between the mobile device and the antenna modules 112 and/or the receiver-transceiver module 104 to receive signals for initiating RePA from the user 108. Because the mobile device has antenna(s) for BLE, Wi-Fi, UWB, and/or other communication protocol(s), the command controller 116 utilizes the antenna modules 112 and/or the receiver-transceiver module 104 to receive RePA signal(s) from the mobile device via BLE, Wi-Fi, UWB, and/or other communication protocol(s). That is, when the antenna modules 112 are in communication with the mobile device of the user 108, the receiver-transceiver module 104 is configured to receive a return signal with a distance identifier from the key fob 106 and the antenna modules 112 are configured to receive RePA signal(s) from the mobile device. By utilizing (1) communication with the key fob 106 to determine a distance to the user 108 and (2) communication with the mobile device to receive signals for initiating RePA functions, the command controller 116 is able to simultaneously determine the distance to the user 108 and receiving RePA signals.

Additionally, or alternatively, the key fob 106 of the illustrated example is configured to be utilized for both (1) determining the distance to the user 108 and (2) sending signals to initiate RePA functions. For example, the key fob 106 is configured to send signals to the vehicle 100 to initiate RePA functions upon communicating with the vehicle 100 to determine the distance between the key fob 106 and the vehicle 100. In some examples, the remote park-assist system of the vehicle 100 utilizes the key fob 106 to send RePA signals if the mobile device has been misplaced by the user 108 and/or has a discharged battery. That is, the key fob 106 of the illustrated example is configured to be utilized as a backup remote device for initiating performance of RePA for the vehicle 100. Additionally, or alternatively, the remote park-assist system of the vehicle 100 may utilize the key fob 106 to send RePA signals if the user 108 prefers carrying only a single remote device for initiating performance of RePA for the vehicle 100.

In some examples, the command controller 116 is configured to limit use of the key fob 106 as a backup remote device for initiating RePA functions. The command controller 116 is configured to limit when the key fob 106 is able to be utilized as a backup device to prevent overuse of the key fob 106 as a backup device. For example, the command controller 116 is configured to (1) limit a speed of the vehicle 100 (e.g., to 2 kilometers per hour) during a motive function initiated via the key fob 106, (2) limit a distance traveled by the vehicle 100 to a predefined distance for each RePA signal sent from the key fob 106, (3) prevent the key fob 106 from being utilized as a backup RePA method when the antenna modules 112 are in communication with the mobile device of the user 108, (4) limit a number of consecutive RePA sessions initiated by the key fob 106 since the last RePA session initiated by the mobile device of the user 108, and/or (5) limit a RePA session initiated by the key fob 106 to a predefined duration of time. In some examples in which a RePA session initiated by the key fob 106 is limited to a predefined duration of time, the RePA session may be extended by the user 108 by selecting a predefined combination of buttons of the key fob 106.

Additionally, or alternatively, the command controller 116 is configured to limit one or more RePA function(s) to discourage daily use of the key fob 106 as backup device. For example, when a RePA signal is received from the key fob 106, the command controller 116 is configured to limit a speed of the vehicle 100 and/or a distance traveled by the vehicle 100 for an autonomous motive function performed by the autonomy unit 114 for RePA. Further, in some examples, the command controller 116 is configured to reduce the rate at which the LF modules 102 transmit the beacon 202 to reduce energy consumption of the key fob 106 caused by receipt and processing of the beacon 202. A processor of the key fob 106 (e.g., a processor 502 of FIG. 5) may also temporarily disable use of the lamp 312 of the key fob 106 while RePA is initiated to reduce energy consumption of the key fob 106.

FIG. 2 depicts a schematic of communication between the key fob 106 and the vehicle 100. In the illustrated example, the communication between the key fob 106 and the vehicle 100 is asymmetrical. That is, one or more of the LF modules 102 sends signals to the key fob 106, and the receiver-transceiver module 104 receives signals from the key fob 106.

For example, the one or more of the LF modules 102 transmits a beacon 202 (e.g., to be received by the key fob 106) in the form of a LF signal. Further, the receiver-transceiver module 104 receives a return signal 204 from the key fob, for example, in the form of a UHF signal. Upon receiving the beacon 202 from one or more of the LF modules 102, the key fob 106 (e.g., via a processor 502 of FIG. 5) determines a distance indicator (e.g., a received signal strength indicator or RSSI) for the received beacon. Further, the key fob (e.g., via the processor 502) includes the distance indicator in the return signal 204 to enable the receiver-transceiver module 104 to identify the distance between the vehicle 100 and the key fob 106. Subsequently, the receiver-transceiver module 104 receives the return signal from the key fob 106, for example, in the form of a UHF signal and determines the distance between the vehicle 100 and the key fob 106 based on the distance identifier within the return signal. Further, in some examples, the return signal 204 includes an authentication token (e.g., an encrypted identifier, an encrypted counter, etc.) to enable the command controller 116 to determine whether the key fob 106 is authorized for communication with the vehicle 100. In some examples, the vehicle 100 may use the same wireless protocol (e.g., BLE, WiFi, UWB, etc.) for both sending the beacon 202 to the key fob 106 and receiving the return signal 204 from the key fob 106. In such examples, the beacon 202 and the return signal 204 may communicate RSSI, time-of-flight, and/or angle-of-arrival information that is utilized for determining the distance between key fob 106 and the vehicle 100.

Additionally, the key fob 106 is configured to send a command signal 206 to the receiver-transceiver module 104 of the vehicle 100 upon the user 108 pressing a button, a predefined sequence and/or combination of button(s) of the key fob 106. For example, the command signal 206 includes an unlock signal, a lock signal, a remote start signal, a RePA signal, etc. Further, the command controller 116 collects the command signal 206 to identify a corresponding vehicle function. For example, if the command signal 206 includes a RePA signal, the command controller 116 causes the autonomy unit 114 to perform motive function(s) for RePA based on the command signal 206.

In operation, the LF modules 102 of the vehicle 100 are configured to transmit the beacon 202 at a predefined interval. An LF antenna of the key fob 106 (e.g., an LF antenna 508 of FIG. 5) is configured to receive the beacon 202 when the key fob 106 is located within a transmission range of the LF modules 102. For example, in normal operation, the transmission range of the LF modules 102 extends beyond the tethering range 118. In response to the LF antenna receiving the beacon 202, a processor of the key fob 106 (e.g., the processor 502) is configured to determine a distance indicator and include the distance indicator in the return signal 204. Subsequently a medium-frequency antenna of the key fob 106 (e.g., a UHF antenna 510 of FIG. 5) is configured to transmit the return signal 204 to the vehicle 100. That is, the medium-frequency antenna is configured to transmit the return signal 204 in response to the LF antenna receiving the beacon 202. In response to the receiver-transceiver module 104 receiving the return signal 204, the command controller 116 identifies the distance indicator within the return signal 204 and compares (1) a distance between the key fob 106 and the vehicle 100 that corresponds with the distance indicator to (2) a threshold distance corresponding to an outer boundary of the tethering range 118. In response to determining that the distance between the key fob 106 and the vehicle 100 is less than or equal to the tethering distance, the command controller 116 enables the autonomy unit 114 to perform RePA based on a RePA signal (e.g., the command signal 206). In response to determining that the distance between the key fob 106 and the vehicle 100 is greater than the tethering distance, the command controller 116 prevents the autonomy unit 114 from performing RePA.

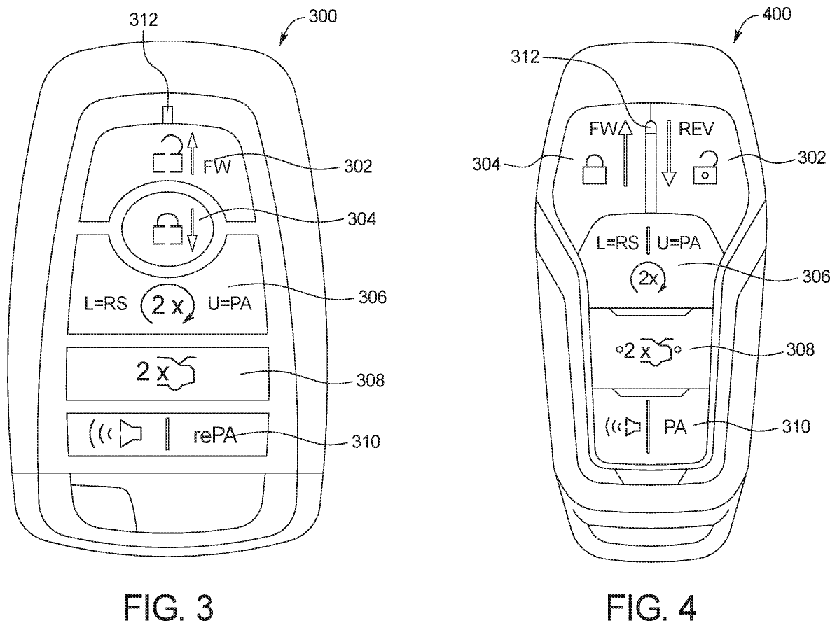

Further, the medium-frequency antenna of the key fob 106 is configured to send a RePA signal in response to the processor identifying that a corresponding predefined combination of buttons of the key fob 106 (e.g., a predefined combination of the buttons 506) has been pressed by the user 108. For example, the processor of the key fob 106 includes an instruction to initiate RePA in the RePA signal in response to identifying that the user 108 has pressed a lock button once (e.g., a lock button 304 of FIG. 3) and subsequently pressed a trigger button (e.g., a trigger button 306 of FIG. 3) twice in succession. The processor of the key fob 106 includes an instruction to perform a forward motion in the RePA signal in response to identifying that the user 108 is simultaneously holding (i) an alert or undesignated button (e.g., an alert button 310 of FIG. 3) and (ii) an unlock button (e.g., an unlock button 302 of FIG. 3). The processor of the key fob 106 includes an instruction to perform a reverse motion in the RePA signal in response to identifying that the user 108 is simultaneously holding (i) the alert or undesignated button and (ii) the lock button. In some examples, in response to one or more buttons being released, the medium-frequency antenna of the key fob 106 is configured to send a corresponding RePA signal to quickly instruct the autonomy unit 114 that the user 108 has stopped providing a command for the reverse or forward motion. In other examples, the autonomy unit 114 detects that the user 108 has stopped providing a command for the reverse or forward motion in response to detecting that the receiver-transceiver module 104 has stopped receiving the corresponding RePA signal over a predefined duration of time.

Further, the processor of the key fob 106 is configured to send an exit signal to deactivate RePA in response to identifying that the user 108 has released all of the fob buttons and subsequently pressed the trigger button, the alert button, and/or another button a predefined number of times (e.g., twice). Additionally, or alternatively, the processor of the key fob 106 is configured to send an exit signal via the medium-frequency antenna in response to identifying that the LF antenna has stopped receiving the beacon 202 at an expected interval.

In the illustrated example, the medium-frequency antenna of the key fob 106 is configured to continue sending the RePA signal while a corresponding combination of buttons is being pressed by the user 108 as long as the LF antenna of the key fob 106 continues to receive the beacon 202 at the predefined interval. For example, because the medium-frequency antenna is unable to simultaneously transmit the return signal 204 for determining the distance to the key fob 106 and the RePA signal for initiating RePA functions, the key fob 106 is configured to only send the RePA signal as long as the LF antenna continues to receive the beacon 202 at the predefined interval. In turn, this arrangement prevents the distance determination of the key fob 106 from interrupting the transmission of the RePA signal. Further, the medium-frequency antenna continues to send the RePA signal in an uninterrupted manner as long as the LF antenna continues to receive the beacon 202 at the predefined interval. In other examples, the processor of the key fob 106 and/or the command controller 116 of the vehicle 100 is configured to schedule predefined time slots for distance determination communication and RePA signal communication to prevent one form of communication from interfering with the other.

Further, to enable the processor of the key fob 106 and/or the command controller 116 of the vehicle 100 to determine that the key fob 106 remains within the tethering range 118 while the RePA signal is being sent, the command controller 116 causes the LF antennas to reduce a signal strength of the beacon 202 upon receiving a RePA signal to initiate RePA when the key fob 106 is within the tethering range 118. For example, prior to determining that a distance indicator received from the key fob 106 is less than or equal to a distance corresponding with an outer boundary of the tethering range 118, the LF modules 102 are configured to transmit the beacon 202 beyond the tethering range 118. Upon determining that a distance indicator received from the key fob 106 is greater than a distance corresponding with an outer boundary of the tethering range 118, the LF modules 102 are configured to transmit the beacon 202 to the tethering range 118 such that key fob 106 is unable to receive the beacon 202 when the key fob 106 is located beyond the tethering range 118.

Additionally, the receiver-transceiver module 104 of the illustrated example is configured to receive the RePA signal. The autonomy unit 114 is configured to perform a motive function for RePA based on the RePA signal. Further, the autonomy unit 114 is configured to stop performing RePA in response to (1) the receiver-transceiver module 104 receiving an exit signal from the key fob 106 and/or (2) the command controller 116 identifying that the receiver-transceiver module 104 has stopped receiving a RePA signal.

FIG. 3 depicts an example key fob 300 in accordance with the teachings herein. That is, the key fob 300 is an example of the key fob 106 of FIGS. 1 and 2. As illustrated in FIG. 3, the key fob 300 includes a plurality of buttons (e.g., buttons 506 of FIG. 5). For example, the key fob 300 includes an unlock button 302 and a lock button 304.

When the unlock button 302 is pressed by the user 108, the key fob 106 is configured to send an unlock signal to the vehicle 100 to unlock one or more locked doors of the vehicle 100 (e.g., via door control units 628 of FIG. 6). For example, when the unlock button 302 is pressed once, the key fob 106 is configured to send a first unlock signal to the vehicle 100 to unlock the driver's door of the vehicle 100. In some examples, when the unlock button 302 is pressed twice within a predetermined period of time (e.g., 3 seconds), the key fob 106 is configured to send a second unlock signal to the vehicle 100 to unlock all of the doors of the vehicle 100. Further, in some examples, when the unlock button 302 is held for a predetermined period of time (e.g., 4 seconds), the key fob 106 is configured to send an open signal to the vehicle 100 to open one or more windows of the vehicle 100 (e.g., via the door control units 628).

When the lock button 304 is pressed by the user 108, the key fob 106 is configured to send an lock signal to the vehicle 100 to lock unlocked door(s) of the vehicle 100 (e.g., via the door control units 628). For example, when the lock button 304 is pressed once, the key fob 106 is configured to send a lock signal to the vehicle 100 to lock the doors of the vehicle 100. In some examples, when the lock button 304 is pressed twice within a predetermined period of time (e.g., 3 seconds), the command controller 116 causes (e.g., via a body control module 624 of FIG. 6) a speaker and/or horn of the vehicle 100 to emit a chirp alert. Further, in some examples, the command controller 116 causes lights to flash upon each pressing of the lock button 304 and/or the doors locking. Additionally, or alternatively, when the lock button 304 is held for a predetermined period of time (e.g., 4 seconds), the key fob 106 is configured to send a close signal to the vehicle 100 to close one or more windows of the vehicle 100 (e.g., via the door control units 628).

The key fob 300 of the illustrated example also includes a trigger button 306 (sometimes referred to as a “2x” button). The trigger button 306, in combination with the other buttons of the key fob 300, is configured to trigger other vehicle functions of the vehicle 100. For example, when the lock button 304 is pressed once and the trigger button 306 is subsequently pressed twice in succession within a predetermined period of time (e.g., 3 seconds), the key fob 106 is configured to send a remote-start signal to the vehicle 100 to remote start or activate an engine of the vehicle 100 (e.g., via an engine control unit 626 of FIG. 6). Further, in some examples when remote-start is active, the key fob 106 is configured to send a remote-start stop signal when the trigger button 306 is pressed only once within a predetermined period of time. Additionally, or alternatively, when the unlock button 302 is pressed once and the trigger button 306 is subsequently pressed twice in succession, the key fob 106 is configured to send a RePA signal to the vehicle 100 to initiate RePA for the vehicle 100 (e.g., via the autonomy unit 114).

In the illustrated example, the key fob 300 also includes a hatch button 308, an alert button 310 (sometimes referred to as a panic button), and a lamp 312 (e.g., an light emitting diode or LED). The hatch button 308 (sometimes referred to as a trunk button or a liftgate button) is configured to initiate opening and/or closing a hatch, a liftgate, a deck lid, a frunk, and/or trunk of the vehicle 100. For example, when the hatch button 308 is pressed twice within a predetermined period of time (e.g., 3 seconds), the key fob 106 is configured to send a hatch signal to actuate the hatch of the vehicle 100. When the hatch is closed, the vehicle 100 (e.g., via a body control module 624 of FIG. 6) is to open the hatch upon receiving the hatch signal. Further, in some examples when the hatch is open, the vehicle 100 (e.g., via the body control module 624) is to close the hatch upon receiving the hatch signal. The alert button 310 (sometimes referred to as a panic button) is configured to initiate an alert (e.g., an audio and/or visual alert) of the vehicle 100 if pushed while the vehicle 100 is off and/or in a non-motive state (e.g., when the vehicle 100 is in a remote start mode with the engine active). For example, when the alert button 310 is pressed by the user 108, the key fob 106 is configured to send the alert signal to the vehicle 100 to emit the alert. Further, the lamp 312 is configured to emit alert(s) to the user 108 regarding the status of vehicle function(s) initiated via the key fob 106. For example, the lamp 312 emits different colors (e.g., red, green) and/or a different sequences (e.g., different combinations of dots and dashes) to emit different alerts to the user 108.

In the illustrated example, each button of the key fob 300 includes a label for both park-assist functionality and non-park-assist functionality. In other examples, one or more buttons of the key fob 300 includes a label only for park-assist functionality or non-park-assist functionality.

FIG. 4 depicts another example key fob 400 in accordance with the teachings herein. That is, the key fob 400 is an example of the key fob 106 of FIGS. 1 and 2. The key fob 400 includes the unlock button 302, the lock button 304, the trigger button 306, the hatch button 308, the alert button 310, and the lamp 312. As illustrated in FIGS. 3 and 4, the unlock button 302, the lock button 304, the trigger button 306, the hatch button 308, the alert button 310, and the lamp 312 are arranged differently on the key fob 400 relative to the key fob 300. In the illustrated example, each button of the key fob 400 includes a label for both park-assist functionality and non-park-assist functionality. In other examples, one or more buttons of the key fob 300 includes a label only for park-assist functionality or non-park-assist functionality. Further, in the illustrated example of FIG. 4, the lock button 304 corresponds with a forward RePA motion and the unlock button 302 corresponds with a reverse RePA motion. Additionally, or alternatively, one or more of the buttons may correspond with different RePA function(s) other than those shown in FIG. 3 and/or FIG. 4.

FIG. 5 is a block diagram of electronic components 500 of the key fob 106 (e.g., the key fob 300, the key fob 400). In the illustrated example, the electronic components 500 include a processor 502, memory 504, buttons 506, the lamp 312, an LF antenna 508, and a UHF antenna 510.

In the illustrated example, the processor 502 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 504 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 504 includes multiple kinds of memory, particularly volatile memory and non-volatile memory.

The memory 504 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 504, the computer readable medium, and/or within the processor 502 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The buttons 506 of the illustrated example are input devices that are configured to receive input information from the user 108 of the vehicle 100. For example, one or more of the buttons 506 are configured to receive requests for remote entry, remote start, unlocking and/or locking a door, opening and/or closing a hatch and/or trunk, emitting an alert, opening and/or closing a door window, remote park-assist, etc. In the illustrated example, the buttons 506 include the unlock button 302, the lock button 304, the trigger button 306, the hatch button 308, and the alert button 310. Further, the lamp 312 (e.g., an LED) of the illustrated example is an output device that is configured to provide output information to the user 108 of the vehicle 100. For example, the lamp 312 is configured to provide output information regarding remote entry, remote start, unlocking and/or locking a door, opening and/or closing a hatch and/or trunk, emitting an alert, opening and/or closing a door window, remote park-assist, etc.

The LF antenna 508 of the illustrated example includes hardware (e.g., processors, memory, storage, antenna, etc.) and software to communicate via LF signals (e.g., 125 kHz to 134.5 kHz, etc.). For example, the LF antenna 508 is configured to receive a beacon message that is transmitted by one or more of the LF modules 102 of the vehicle 100. Further, the processor 502 is configured to identify a distance that the beacon message has traveled based on characteristics of the beacon message.

The UHF antenna 510 of the illustrated example is configured to include hardware and software to communicate via ultra-high frequency (UHF) signals (e.g., 314 MHz to 904 MHz, etc.) and/or other medium-frequency signals. For example, the UHF antenna 510 is configured to transmit a return signal to the receiver-transceiver module 104 of the vehicle 100. In some examples, the processor 502 includes a corresponding distance indicator (e.g., a received signal strength indicator) in the return signal to enable the receiver-transceiver module 104 to identify the distance between the vehicle 100 and the key fob 106. Further, the UHF antenna 510 is configured to transmit an unlock signal, a lock signal, a remote start signal, a RePA signal, and/or any other signal that corresponds with a predefined sequence of the buttons 506 (e.g., the buttons 302, 304, 306, 308, 310) pressed by the user 108.

Further, in some examples, the electronic components 500 of the key fob 106 also include a BLE antenna 512 to enable the key fob 106 to communicate with the vehicle 100 via BLE communication. For example, the BLE antenna 512 includes hardware and software to communicate via BLE signals. In such examples, the BLE antenna 512 is configured to transmit an unlock signal, a lock signal, a remote start signal, a RePA signal, and/or any other signal that corresponds with a predefined sequence of the buttons 506 (e.g., the buttons 302, 304, 306, 308, 310) pressed by the user 108. In examples in which the key fob 106 includes the BLE antenna 512, the key fob 106 is able to simultaneously (1) communicate via the LF antenna 508 and the UHF antenna 510 to identify the distance between the key fob 106 and the vehicle 100 and (2) communicate RePA signals via the BLE antenna 512. In turn, the key fob 106 that includes the BLE antenna 512 is configured to be utilized for initiating RePA functions for the vehicle 100 without affecting the beacon 202 and the return signal 204 sequence for the LF antenna 508 and the UHF antenna 510.

Further, in some examples, UWB or Wi-Fi communication and time-of-flight or angle-of-arrival methodologies are utilized in lieu of or in addition to BLE communication for estimating a distance between the key fob 106 and the vehicle 100. Additionally, or alternatively, BLE communication and time-of-flight and/or angle-of-arrival methodologies (e.g., instead of received signal strength indicators) are implemented by the key fob 106 and the vehicle 100 to determine the distance between the two.

FIG. 6 is a block diagram of electronic components 600 of the vehicle 100. In the illustrated example, the electronic components 600 include an onboard computing platform 602, communication modules 604, sensors 606, output devices 608, electronic control units (ECUs) 610, and a vehicle data bus 612.

The onboard computing platform 602 includes a processor 614 (also referred to as a microcontroller unit and a controller) and memory 616. In the illustrated example, the processor 614 of the onboard computing platform 602 is structured to include the command controller 116. In other examples, the command controller 116 is incorporated into another ECU with its own processor and memory. The processor 614 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 616 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 616 includes multiple kinds of memory, particularly volatile memory and non-volatile memory.

The memory 616 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 616, the computer readable medium, and/or within the processor 614 during execution of the instructions.

The communication modules 604 are configured to wirelessly communicate with the key fob 106 and/or another device. In the illustrated example, the communication modules 604 include the LF modules 102 that are configured for LF communication, the receiver-transceiver module 104 that is configured for UHF and/or other medium-frequency communication, and the communication module 110 and the antenna modules 112 that are configured for BLE communication.

The sensors 606 are arranged in and/or around the vehicle 100 to monitor properties of the vehicle 100 and/or an environment in which the vehicle 100 is located. One or more of the sensors 606 may be mounted to measure properties around an exterior of the vehicle 100. Additionally, or alternatively, one or more of the sensors 606 may be mounted inside a cabin of the vehicle 100 or in a body of the vehicle 100 (e.g., an engine compartment, wheel wells, etc.) to measure properties in an interior of the vehicle 100. For example, the sensors 606 include accelerometers, odometers, tachometers, pitch and yaw sensors, wheel speed sensors, microphones, tire pressure sensors, biometric sensors and/or sensors of any other suitable type.

In the illustrated example, the sensors 606 include range-detection sensors 618. As used herein, a “range-detection sensor” refers to an electronic device that is configured to collect information to detect a presence of and distance to nearby object(s). In the illustrated example, the range-detection sensors 618 include proximity sensors and/or cameras. The proximity sensors are configured to detect the presence, proximity, and/or location of object(s) near the vehicle 100. For example, the proximity sensors include radar sensor(s), LIDAR sensor(s), ultrasonic sensor(s), and/or any other sensor configured to detect the presence, proximity, and/or location of nearby object(s). A radar sensor detects and locates an object via radio waves, a LIDAR sensor detects and locates the object via lasers, and an ultrasonic sensor detects and locates the object via ultrasound waves. Further, the cameras are configured to capture image(s) and/or video of a surrounding area of the vehicle 100 to enable nearby object(s) to be identified and located. In the illustrated example, the range-detection sensors 618 are located along the vehicle 100 to enable the range-detection sensors 618 to monitor a surrounding area of the vehicle 100. For example, the range-detection sensors 618 monitor the surrounding area of the vehicle 100 to enable the autonomy unit 114 to perform autonomous motive functions for the vehicle 100.

The output devices 608 provide an interface for the vehicle 100 to present information to the user 108. The output devices 608 may include digital interface(s) and/or analog interface(s). In some examples, the output devices 608 include instrument cluster output(s) and/or a display. Further, in the illustrated example, the output devices 608 include exterior lamps 620 and a horn 622. For example, the exterior lamps 620 and/or the horn 622 is configured to emit an alert in response to user 108 pressing the alert button 310 of the key fob 106.

The ECUs 610 monitor and control the subsystems of the vehicle 100. For example, the ECUs 610 are discrete sets of electronics that include their own circuit(s) (e.g., integrated circuits, microprocessors, memory, storage, etc.) and firmware, sensors, actuators, and/or mounting hardware. The ECUs 610 communicate and exchange information via a vehicle data bus (e.g., the vehicle data bus 612). Additionally, the ECUs 610 may communicate properties (e.g., status of the ECUs 610, sensor readings, control state, error and diagnostic codes, etc.) to and/or receive requests from each other. For example, the vehicle 100 may have dozens of the ECUs 610 that are positioned in various locations around the vehicle 100 and are communicatively coupled by the vehicle data bus 612. In the illustrated example, the ECUs 610 include the autonomy unit 114, a body control module 624, an engine control unit 626, and one or more door control units 628.

The autonomy unit 114 controls performance of autonomous and/or semi-autonomous driving maneuvers of the vehicle 100 (e.g., for remote park-assist) based upon, at least in part, data collected by the range-detection sensors 618 of the vehicle 100. The body control module 624 controls one or more subsystems throughout the vehicle 100, such as an immobilizer system, etc. For example, the body control module 624 includes circuits that drive one or more of relays (e.g., to control wiper fluid, etc.), brushed direct current (DC) motors (e.g., to control power seats, wipers, etc.), stepper motors, LEDs, etc. Further, the engine control unit 626 controls operation of an engine (e.g., an internal combustion engine, an electric motor, a hybrid engine) of the vehicle 100. For example, the engine control unit 626 is configured to remote start the engine upon receiving a signal to do so.

The door control units 628 control one or more subsystems located on doors (e.g., a driver door, a passenger door, a hatch and/or trunk, etc.) of the vehicle 100. For example, each door of the vehicle 100 includes a respective one of the door control units 628. Each of the door control units 628 includes circuits that drive relay(s), brushed DC motor(s), stepper motor(s), LEDs, etc. for the operation of power windows, power locks, power mirrors, etc. for the respective door of the vehicle 100.

In some examples, each of door control units 628 is communicatively coupled to an electronic latch (also referred to as an e-latch) of the respective door. The e-latch is an electromechanical device that actuates a door latch to latch and/or unlatch the door. For example, the lock state is stored in memory of one or more of the door control units 628 and/or the body control module 624. Further, the e-latch is utilized for a remote entry system and/or a passive entry system of the vehicle 100. For a remote entry system, one or more of the door control units 628 instructs a respective e-latch to (1) place the latch memory in an unlock state for the respective door in response to the command controller 116 receiving an unlock signal from the key fob 106 and/or (2) lock the respective door in response to the command controller 116 receiving a lock signal from the key fob 106. For a passive entry system, one or more of the door control units 628 primes a respective e-latch of the respective door for unlocking in response to the command controller 116 detecting that the key fob 106 is located within a predetermined distance of the vehicle 100. Subsequently, the e-latch actuates a door latch to unlatch the respective door in response to detecting that a door handle of the door is being grasped by the user 108. In some examples, one of the door control units 628 corresponds with a hatch and/or trunk of the vehicle 100. That one of the door control units 628 is configured to open and/or close the hatch and/or trunk in response to the command controller 116 receiving a signal to do so from the key fob 106.

The vehicle data bus 612 communicatively couples the onboard computing platform 602, the communication modules 604, the sensors 606, the output devices 608, and the ECUs 610. In some examples, the vehicle data bus 612 includes one or more data buses. The vehicle data bus 612 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc. In some examples, the vehicle data bus 612 includes a wireless communication network (e.g., WiFi or Bluetooth).

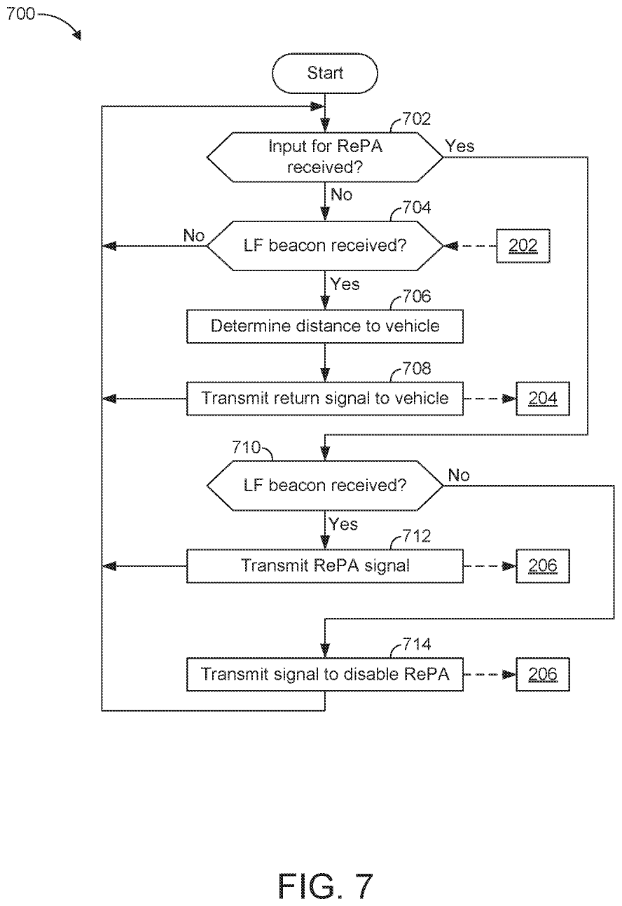

FIG. 7 is a flowchart of an example method 700 to initiate remote park-assist utilizing a key fob and medium-frequency communication (e.g., UHF communication). The flowchart of FIG. 7 is representative of machine readable instructions that are stored in memory (such as the memory 504 of FIG. 5) and include one or more programs which, when executed by a processor (such as the processor 502 of FIG. 5), cause the key fob 106 (e.g., the key fob 300, the key fob 400) to initiate remote park-assist via medium-frequency communication. While the example program is described with reference to the flowchart illustrated in FIG. 7, many other methods may alternatively be used. For example, the order of execution of the blocks may be rearranged, changed, eliminated, and/or combined to perform the method 700. Further, because the method 700 is disclosed in connection with the components of FIGS. 1-5, some functions of those components will not be described in detail below.

Initially, at block 702, the processor 502 determines whether an input for RePA has been received from the user 108 via the buttons 506 (e.g., the buttons 302, 304, 306, 308, 310) of the key fob 106. For example, the processor 502 determines whether an input to initiate RePA, initiate a forward motion, initiate a reverse motion, etc. has been received via the buttons 506. In response to the processor 502 determining that an input for RePA has not been received, the method 700 proceeds to block 704.

At block 704, the processor 502 determines whether the LF antenna 508 of the key fob 106 has received the beacon 202 from the vehicle 100 (e.g., within a predefined period of time). In response to the processor 502 determining that the LF antenna 508 has not received the beacon 202, the method 700 returns to block 702. Otherwise, in response to the processor 502 determining that the LF antenna 508 has received the beacon 202, the method 700 proceeds to block 706 at which the processor 502 determines a distance indicator (e.g., a received signal strength indicator) that identifies a distance between the key fob 106 and the vehicle 100. Further, the processor 502 includes the distance indicator in the return signal 204 to be sent to the vehicle 100. At block 708, the UHF antenna 510 transmits the return signal 204 to the vehicle 100.

Returning to block 702, the method 700 proceeds to block 710 in response to the processor 502 determining that an input for RePA has been received. At block 710, the processor 502 determines whether the LF antenna 508 has (1) continued to receive the beacon 202 from the vehicle 100 at a predefined interval of the beacon 202 and/or (2) received the beacon 202 within a predefined period of time. For example, if the beacon 202 is transmitted at a predefined interval of 2 seconds, the processor 502 determines whether the LF antenna 508 has continued to receive the beacon 202 at the predefined interval. For example, if the processor 502 has not identified the predefined interval of the beacon 202, the processor 502 determines whether the LF antenna 508 has the beacon 202 within a predefined period of time (e.g., 3 seconds).

In response to LF antenna 508 (1) continuing to receive the beacon 202 at a predefined interval and/or (2) receiving the beacon 202 within a predefined period of time, the LF antenna 508 determines that the key fob 106 is within the tethering range 118 of the vehicle 100 for RePA and proceeds to block 712. At block 712, the UHF antenna 510 of the key fob 106 transmits the command signal 206 (e.g., a RePA signal) to the vehicle 100 to initiate performance of RePA. Upon completing block 712, the method 700 returns to block 702.

Otherwise, in response to LF antenna 508 not (1) continuing to receive the beacon 202 at a predefined interval and/or (2) receiving the beacon 202 within a predefined period of time, the LF antenna 508 determines that the key fob 106 is beyond the tethering range 118 of the vehicle 100 for RePA and proceeds to block 714. At block 714, the UHF antenna 510 of the key fob 106 transmits the command signal 206 (e.g., a RePA signal) to the vehicle 100 to temporarily disable performance of RePA. Upon completing block 714, the method 700 returns to block 702.

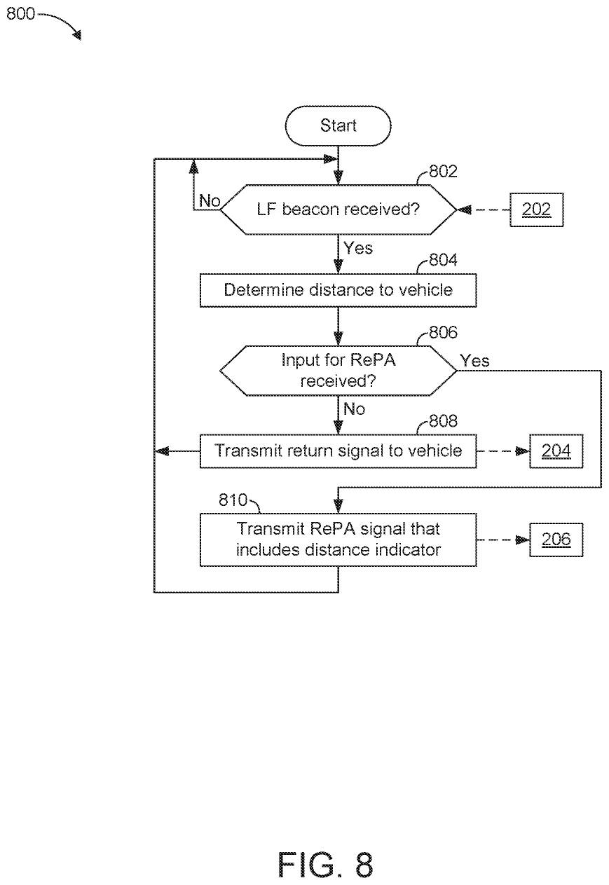

FIG. 8 is a flowchart of an example method 800 to initiate remote park-assist utilizing a key fob and low-energy communication (e.g., BLE communication). The flowchart of FIG. 8 is representative of machine readable instructions that are stored in memory (such as the memory 504 of FIG. 5) and include one or more programs which, when executed by a processor (such as the processor 502 of FIG. 5), cause the key fob 106 (e.g., the key fob 300, the key fob 400) to initiate remote park-assist via low-energy communication. While the example program is described with reference to the flowchart illustrated in FIG. 8, many other methods may alternatively be used. For example, the order of execution of the blocks may be rearranged, changed, eliminated, and/or combined to perform the method 700. Further, because the method 800 is disclosed in connection with the components of FIGS. 1-5, some functions of those components will not be described in detail below.

Initially, at block 802, the processor 502 determines whether the LF antenna 508 of the key fob 106 has received the beacon 202 from the vehicle 100 (e.g., within a predefined period of time). In response to the processor 502 determining that the LF antenna 508 has not received the beacon 202, the method 800 returns to block 802. Otherwise, in response to the processor 502 determining that the LF antenna 508 has received the beacon 202, the method 800 proceeds to block 804 at which the processor 502 determines a distance indicator (e.g., a received signal strength indicator) that identifies a distance between the key fob 106 and the vehicle 100.

At block 806, the processor 502 determines whether an input for RePA has been received from the user 108 via the buttons 506 (e.g., the buttons 302, 304, 306, 308, 310) of the key fob 106. For example, the processor 502 determines whether an input to initiate RePA, initiate a forward motion, initiate a reverse motion, etc. has been received via the buttons 506. In response to the processor 502 determining that an input for RePA has not been received, the method 800 proceeds to block 808. At block 808, the processor 502 includes the distance indicator in the return signal 204, and the BLE antenna 512 subsequently transmits the return signal 204 to the vehicle 100. Upon completing block 808, the method 800 returns to block 802. Otherwise, in response to the processor 502 determining that an input for RePA has been received, the method 800 proceeds to block 810. At block 810, the processor 502 includes the distance indicator in the command signal 206, and the BLE antenna 512 subsequently transmits the command signal 206 (e.g., a RePA signal) to the vehicle 100 to initiate performance of RePA. Upon completing block 810, the method 800 returns to block 802.

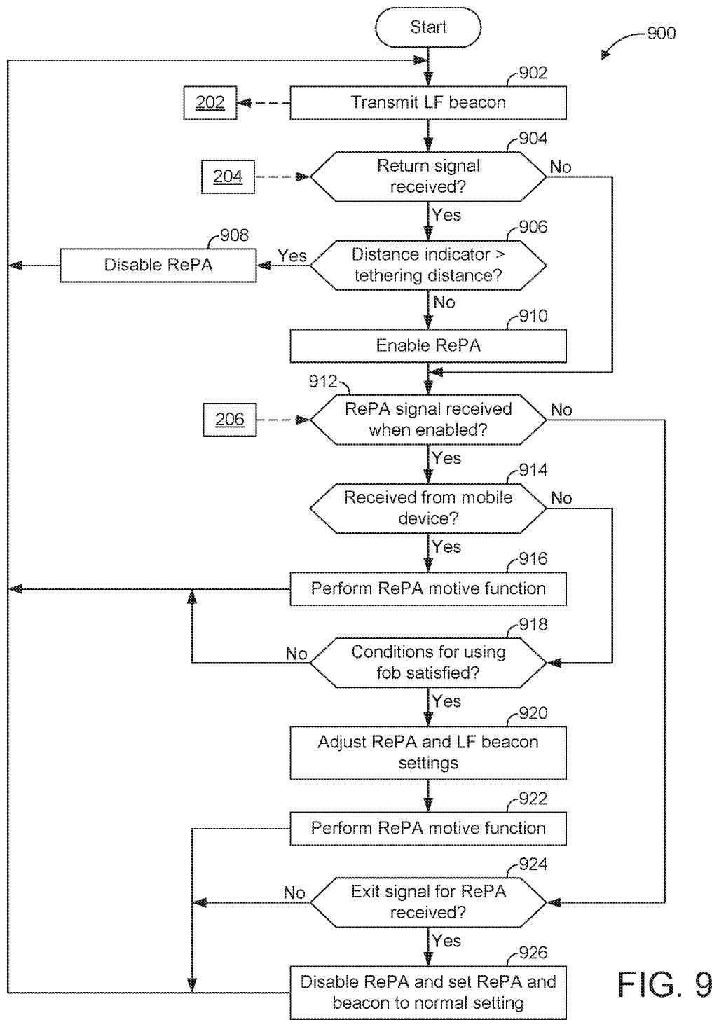

FIG. 9 is a flowchart of an example method 900 to perform remote park-assist based on communication with a key fob. The flowchart of FIG. 9 is representative of machine readable instructions that are stored in memory (such as the memory 616 of FIG. 6) and include one or more programs which, when executed by a processor (such as the processor 614 of FIG. 6), cause the vehicle 100 to implement the example command controller 116 of FIGS. 1 and 6. While the example program is described with reference to the flowchart illustrated in FIG. 9, many other methods of implementing the example command controller 116 may alternatively be used. For example, the order of execution of the blocks may be rearranged, changed, eliminated, and/or combined to perform the method 900. Further, because the method 900 is disclosed in connection with the components of FIGS. 1-2 and 6, some functions of those components will not be described in detail below.

Initially, at block 902, the LF modules 102 transmit the beacon 202 at a predefined interval. For example, the LF modules 102 initially transmit the beacon 202 based on a normal setting. In the normal setting the LF modules 102 transmit the beacon 202 at a signal strength that enables the beacon 202 to be received by the key fob 106 at a location that is outside of the tethering range 118. At block 904, the command controller 116 determines whether the return signal 204 has been received from the key fob 106. For example, the receiver-transceiver module 104 receives the return signal 204 when the return signal 204 is in the form of medium-frequency communication (e.g., UHF communication), and/or the antenna modules 112 and the communication module 110 receive the return signal 204 when the return signal 204 is in the form of low-energy communication (e.g., BLE communication). In response to the command controller 116 determining that the return signal 204 has not been received, the method 900 proceeds to block 912. Otherwise, in response to the command controller 116 determining that the return signal 204 has been received, the method 900 proceeds to block 906.

At block 906, the command controller 116 determines whether the distance indicator identifies a distance between the key fob 106 and the vehicle 100 that is greater than a tethering distance between the tethering range 118 and the vehicle 100. In response to the command controller 116 determining that the distance identified by the distance indicator is greater than the tethering distance, the method 900 proceeds to block 908 at which the command controller 116 temporarily disables RePA for the vehicle 100. Otherwise, in response to the command controller 116 determining that the distance identified by the distance indicator is less than or equal to the tethering distance, the method 900 proceeds to block 910 at which the command controller 116 enables the autonomy unit 114 to initiate and perform RePA.

At block 912, the command controller 116 determines whether a RePA signal has been received while RePA is enabled. For example, the receiver-transceiver module 104 receives the command signal 206 when the command signal 206 is in the form of medium-frequency communication (e.g., UHF communication), and/or the antenna modules 112 and the communication module 110 receive the command signal 206 when the command signal 206 is in the form of low-energy communication (e.g., BLE communication). In response to the command controller 116 determining that a RePA signal has not been received while RePA is enabled, the method 900 proceeds to block 924. Otherwise, in response to the command controller 116 determining that a RePA signal has been received while RePA is enabled, the method 900 proceeds to block 914.

At block 914, the command controller 116 determines whether the RePA signal was received from a mobile device (a smart phone, a wearable, a smart watch, a tablet, etc.) or a key fob. In response to the command controller 116 determining that the RePA signal was received from a mobile device, the method 900 proceeds to block 916 at which the autonomy unit 114 performs a motive function for RePA based on the received RePA signal. Upon completing block 916, the method 900 returns to block 902. Otherwise, in response to the command controller 116 determining that the RePA signal was not received from a mobile device (i.e., the RePA signal was not received from the key fob 106), the method 900 proceeds to block 918.

At block 918, the command controller 116 determines whether conditions for utilizing the key fob 106 to initiate RePA functions are satisfied. For example, the command controller 116 determines whether (1) the antenna modules 112 are in communication with the mobile device of the user 108, (2) the key fob 106 has initiated a number of RePA sessions that exceed a threshold number of sessions since the mobile device was last used to initiate RePA functions, (3) the key fob 106 has initiated a number of RePA sessions within a predefined duration of time that exceed a threshold number of sessions, etc. In response to the command controller 116 determining that the conditions for utilizing the key fob 106 are not satisfied, the method 900 returns to block 902. Otherwise, in response to the command controller 116 determining that the conditions for utilizing the key fob 106 are satisfied, the method 900 proceeds to block 920.

At block 920, the command controller 116 adjusts RePA settings and beacon settings. For example, the command controller 116 reduces the signal strength of the beacon 202 transmitted by the LF modules 102 such that the LF antenna 508 of the key fob 106 is only able to receive the beacon 202 when the key fob 106 is within the tethering range 118. Additionally, or alternatively, the command controller 116 limits one or more functions performed by the autonomy unit 114 for RePA. For example, the command controller 116 limits a speed of the vehicle 100 and/or a distance traveled by the vehicle 100 while performing a RePA function. In some examples, the command controller 116 reduces the rate at which the LF modules 102 transmit the beacon 202 to reduce energy consumption of a battery of the key fob 106 caused by receipt and processing of the beacon 202. Further in some examples, the processor 502 of the key fob 106 temporarily disables use of the lamp 312 of the key fob 106 while RePA is initiated to reduce energy consumption of the key fob 106. At block 922, the autonomy unit 114 performs a motive function for RePA based on the received RePA signal and the adjusted RePA settings. Upon completing block 922, the method 900 returns to block 902.

Returning to block 924, the command controller 116 determines whether an exit signal for RePA has been received. For example, the receiver-transceiver module 104 receives the command signal 206 including the exit signal when the command signal 206 is in the form of medium-frequency communication (e.g., UHF communication), and/or the antenna modules 112 and the communication module 110 receive the command signal 206 including the exit signal when the command signal 206 is in the form of low-energy communication (e.g., BLE communication). In response to the command controller 116 determining that an exit signal has not been received, the method 900 returns to block 902. Otherwise, in response to the command controller 116 determining that an exit signal has been received, the method 900 proceeds to block 926 at which the command controller 116 temporarily disables RePA and resets the beacon settings and the RePA settings to a normal setting. Upon completing block 926, the method 900 returns to block 902. Further, in some examples, the command controller 116 temporarily disables RePA and resets the beacon settings and the RePA settings to a normal setting based on a predefined timer. For example, in response to the command controller 116 determining that a RePA input has not been received within a predefined period of time (e.g., 15 seconds) of RePA being initiated and/or the last RePA input, the method 900 proceeds to block 926 to disable RePA and/or resets the beacon and RePA settings.

An example disclosed vehicle system for remote park-assist (RePA) includes a key fob. The key fob includes a low frequency (LF) antenna to receive a beacon and an ultra-high frequency (UHF) antenna to transmit a return signal including a distance indicator and a RePA signal. The example disclosed vehicle system also includes a vehicle. The vehicle includes an LF module to transmit the beacon at a predefined interval, a receiver-transceiver module to receive the return signal and the RePA signal, a controller to enable RePA responsive to determining that the distance indicator is less than a tethering threshold distance, and an autonomy unit to perform RePA based on the RePA signal.

In some examples, the controller of the vehicle is configured to disable RePA responsive to determining that the distance indicator is greater than or equal to the tethering threshold distance. In some examples, the UHF antenna is configured to transmit the return signal in response to the LF antenna receiving the beacon.

In some examples, prior to determining that the distance indicator is less than the tethering threshold distance, the LF module is configured to transmit the beacon beyond the tethering threshold distance. In some such examples, upon determining that the distance indicator is less than the tethering threshold distance, the LF module is configured to transmit the beacon to the tethering threshold distance.

In some examples, the LF antenna is configured to receive signals between 125 kHz and 134.5 kHz and the UHF antenna is configured to transmit signals between 314 MHz and 904 MHz.

In some examples, the key fob includes buttons. In such examples, the UHF antenna is configured to send the RePA signal in response to a predefined combination of the buttons being pressed. In some such examples, the UHF antenna is configured to continue sending the RePA signal while the predefined combination of the buttons is held and the LF antenna continues to receive the beacon at the predefined interval. Further, in some such examples the UHF antenna transmits an exit signal in response to at least one of the predefined combination of the buttons being released and the LF antenna not continuing to receive the beacon at the predefined interval. Moreover, in some such examples, the autonomy unit is configured to stop performing RePA in response to the receiver-transceiver module receiving the exit signal. In some examples, the autonomy unit is configured to stop performing RePA in response to the controller determining that the receiver-transceiver module has stopped receiving the RePA signal.

In some examples, the key fob includes a processor that is configured to determine the distance indicator based on the beacon received by the LF antenna and include the distance indicator in the return signal transmitted by the UHF antenna.

In some examples, the controller limits a RePA session initiated by the key fob to a predefined duration of time. In some examples, when the RePA signal is received from the key fob, the controller is configured to limit at least one of a speed and a travel distance of an autonomous motive function performed by the autonomy unit for RePA.

In some examples, the vehicle includes a low-energy module configured for communication with a mobile device. In some such examples, when the low-energy module is in communication with the mobile device, the receiver-transceiver module is configured to receive the return signal from the key fob and the low-energy module is configured to receive a second RePA signal form the mobile device. Further, in some such examples, the controller prevents the key fob from initiating RePA when the low-energy module is in communication with the mobile device. Further, in some such examples, after the autonomy unit last performs RePA based on communication with the mobile device, the controller limits a number of consecutive RePA sessions initiated by the key fob to a predefined number (e.g., 5 RePA sessions).

An example disclosed method includes transmitting a beacon via a low frequency (LF) module of a vehicle and transmitting, via a UHF antenna of a key fob, a return signal that includes a distance indicator in response to an LF antenna of the key fob receiving the beacon. The example disclosed method also includes, upon receiving the return signal via a receiver-transceiver module of the vehicle, enabling RePA, via a vehicle processor, responsive to determining the distance indicator is less than a tethering threshold distance. The example disclosed method also includes receiving, via the receiver-transceiver module, a RePA signal transmitted by the UHF antenna while RePA is enabled and performing RePA via an autonomy unit based on the RePA signal.

An example disclosed vehicle includes an LF module configured to transmit a beacon at a predefined interval and a receiver-transceiver module configured to receive a return signal and a RePA signal from a key fob. The return signal includes a distance indicator that identifies a distance to the key fob. The example disclosed vehicle also includes a controller configured to enable RePA responsive to determining that the distance indicator of the return signal is less than a tethering threshold distance. The example disclosed vehicle also includes an autonomy unit to perform RePA based on the RePA signal that is received by the receiver-transceiver module while RePA is enabled.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively. Additionally, as used herein, the terms “module” and “unit” refer to hardware with circuitry to provide communication, control and/or monitoring capabilities. A “module” and a “unit” may also include firmware that executes on the circuitry.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A vehicle system for remote park-assist (RePA), the vehicle system comprising:
a key fob including:
a low frequency (LF) antenna to receive a beacon; and
an ultra-high frequency (UHF) antenna to transmit a return signal including a distance indicator and a RePA signal; and
a vehicle including:
an LF module to transmit the beacon at a predefined interval;
a receiver-transceiver module to receive the return signal and the RePA signal;
a controller to enable RePA responsive to determining that the distance indicator is less than a tethering threshold distance; and
an autonomy unit to perform RePA based on the RePA signal.

2. The vehicle system of claim 1, wherein the controller of the vehicle is configured to disable RePA responsive to determining that the distance indicator is greater than or equal to the tethering threshold distance.

3. The vehicle system of claim 1, wherein the UHF antenna is configured to transmit the return signal in response to the LF antenna receiving the beacon.

4. The vehicle system of claim 1, wherein, prior to determining that the distance indicator is less than the tethering threshold distance, the LF module is configured to transmit the beacon beyond the tethering threshold distance.

5. The vehicle system of claim 4, upon determining that the distance indicator is less than the tethering threshold distance, the LF module is configured to transmit the beacon to the tethering threshold distance.

6. The vehicle system of claim 1, wherein the LF antenna is configured to receive signals between 125 kHz and 134.5 kHz and the UHF antenna is configured to transmit signals between 314 MHz and 904 MHz.

7. The vehicle system of claim 1, wherein the key fob includes buttons, wherein the UHF antenna is configured to send the RePA signal in response to a predefined combination of the buttons being pressed.

8. The vehicle system of claim 7, wherein the UHF antenna is configured to continue sending the RePA signal while the predefined combination of the buttons is held and the LF antenna continues to receive the beacon at the predefined interval.

9. The vehicle system of claim 8, wherein the UHF antenna transmits an exit signal in response to at least one of the predefined combination of the buttons being released and the LF antenna not continuing to receive the beacon at the predefined interval.

10. The vehicle system of claim 9, wherein the autonomy unit is configured to stop performing RePA in response to the receiver-transceiver module receiving the exit signal.

11. The vehicle system of claim 1, wherein the autonomy unit is configured to stop performing RePA in response to the controller determining that the receiver-transceiver module has stopped receiving the RePA signal.

12. The vehicle system of claim 1, wherein the key fob includes a processor that is configured to:
determine the distance indicator based on the beacon received by the LF antenna; and
include the distance indicator in the return signal transmitted by the UHF antenna.

13. The vehicle system of claim 1, wherein the controller limits a RePA session initiated by the key fob to a predefined duration of time.

14. The vehicle system of claim 1, wherein, when the RePA signal is received from the key fob, the controller is configured to limit at least one of a speed and a travel distance of an autonomous motive function performed by the autonomy unit for RePA.

15. The vehicle system of claim 1, wherein the vehicle includes a low-energy module configured for communication with a mobile device.

16. The vehicle system of claim 15, wherein, when the low-energy module is in communication with the mobile device, the receiver-transceiver module is configured to receive the return signal from the key fob and the low-energy module is configured to receive a second RePA signal form the mobile device.

17. The vehicle system of claim 16, wherein the controller prevents the key fob from initiating RePA when the low-energy module is in communication with the mobile device.

18. The vehicle system of claim 16, wherein, after the autonomy unit last performs RePA based on communication with the mobile device, the controller limits a number of consecutive RePA sessions initiated by the key fob to predefined number.

19. A method comprising:
transmitting a beacon via a low frequency (LF) module of a vehicle;
transmitting, via a UHF antenna of a key fob, a return signal that includes a distance indicator in response to an LF antenna of the key fob receiving the beacon;
upon receiving the return signal via a receiver-transceiver module of the vehicle, enabling RePA, via a vehicle processor, responsive to determining the distance indicator is less than a tethering threshold distance;
receiving, via the receiver-transceiver module, a RePA signal transmitted by the UHF antenna while RePA is enabled; and
performing RePA via an autonomy unit based on the RePA signal.

20. A vehicle comprising:
an LF module configured to transmit a beacon at a predefined interval;
a receiver-transceiver module configured to receive a return signal and a RePA signal from a key fob, the return signal including a distance indicator that identifies a distance to the key fob;
a controller configured to enable RePA responsive to determining that the distance indicator of the return signal is less than a tethering threshold distance; and
an autonomy unit to perform RePA based on the RePA signal that is received by the receiver-transceiver module while RePA is enabled.
